(19) United States
(12) Patent Application Publication
(10) Pub. No.: US 2003/0033595 A1
(43) Pub. Date: Feb. 13, 2003

(54) Automated HDL modifying apparatus and computer-readable recording medium in which program for automatically modifying HDL is recorded

(75) Inventors: Miki Takagi, Kawasaki (JP); Hiroji Takeyama, Kawasaki (JP); Hiroshi Noguchi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kamasaki (JP)

(21) Appl. No.: 09/986,818

(22) Filed: Nov. 13, 2001

(30) Foreign Application Priority Data
Jun. 22, 2001 (JP) 2001-189337

(51) Int. Cl. G06F 9/45

(52) U.S. Cl. 717/143

(57) ABSTRACT

An apparatus is provided for automatically modifying serious semantic grammar errors in an HDL description and to clearly show the modified portions. For these purposes, the apparatus includes: means for detecting a portion in which variables on the right and the left sides of an assignment statement are inconsistent in type; a template for converting the type of the variable on the right side of the assignment statement into that of the variable on the left side; means for modifying the portion into a correct description by applying the type conversion function to the right side of the assignment statement having the portion; and means for attaching a comment about the modification to the modified portion, and is used to automatically modify inappropriate descriptions in the design information of an electronic system or of a logic circuit described in a hardware description language such as VHDL and Verilog-HDL.

### BACKGROUND OF THE INVENTION

1. Field of the Invention

The present invention relates to an apparatus for automatically modifying inappropriate descriptions in the design information of electronic systems or of logic circuits, which is described in a hardware description language (HDL) such as VHDL {VHSIC (Very High Speed Integrated Circuit) HDL} and Verilog-HDL. And the invention relates also to a computer-readable recording medium in which a program for automatically modifying such inappropriate descriptions is recorded.

2. Description of the Related Art

At designing semiconductor integrated circuits such as LSI (Large Scale Integration), HDLs, such as VHDL and Verilog-HDL, are used to describe the design information of their logic circuits. In contrast to ordinary software programming languages, HDLs are suitable for use in describing the functions and the structure of electronic systems and logic circuits, and particularly in describing hierarchy designs, elevating the design level from a logic gate level to a micro architecture level. On the basis of the design information (hereinafter also called “HDL description”) described in an HDL, a logic circuit (netlist) is automatically synthesized by a logic synthesis tool.

Prior to the logic synthesis performed, or prior to inputting an HDL description to the logic synthesis tool, the HDL description is checked (syntax check) for grammar errors. On the occasion of the grammar error check, there could be employed such techniques as disclosed in the following publicized applications.

For example, in Japanese Unexamined Patent Application Publication No. HEI 2-294736, rather minor syntactic grammar errors, such as that a semicolon “;”, required at the end of each statement, is omitted, are detected to be automatically modified. With this technique employed, even if a “;” is omitted at the end of a statement in a source program, the “;” can be automatically inserted.

Further, in Japanese Unexamined Patent Application Publication No. HEI 6-44081, if the types of variables disagree between on the right side and the left side of an assignment statement in an input source program described in a PASCAL language, an error message is output for notifying the occurrence of the disagreement.

If an HDL description is checked for grammar errors using the technique disclosed in Japanese Unexamined Patent Application Publication No. HEI 2-294736, it is possible to automatically modify the above syntactic grammar errors (minor ones), whereas it is impossible to automatically modify semantic grammar errors (serious ones), such as that the types of variables on the both sides of an assignment statement disagree.

Accordingly, as to the semantic grammar errors, it has been necessary for a designer (user) to modify them by manual operation, making reference to error messages output from an HDL processor system. At that time, since the error messages do not specify what modifications are required, it is often impossible to resolve such a semantic grammar error in one modification step, thereby becoming a burden on the designer. Additionally, since the semantic grammar errors occur in a relatively high frequency, their modifications have been putting a considerable burden on the designer.

Still further, after an automatic modification of the HDL description performed, it is still necessary for a designer to evaluate whether the modification having been carried out complies with the designer's intention, or whether the modification thus carried out is the appropriate one. In the conventional techniques, however, since the result of the modification shows no sign nor mark indicating where the actual modification performed, difficulties are confronted in acknowledging where and in what way the modification has been performed, thereby imposing a significant burden on the designer.

If an HDL description is checked for grammar errors using the technique disclosed in Japanese Unexamined Patent Application Publication No. HEI 6-44081, a designer is merely notified, with an error message, of an occurrence of a semantic grammar error of inconsistency in variable type between the both sides of an assignment statement, but the grammar error would never be automatically modified. Additionally, even if the designer is notified with the error message where the error occurs and what the error is, the designer is not always be so familiar with all the grammar errors that the designer's time-consuming manual modification, with reference to grammar textbooks or something, has often been necessitated, thus imposing an extreme burden on the designer.

In the meantime, with the conventional techniques, it is merely possible to detect grammar errors, but meanwhile, it is impossible to detect or automatically modify the portions (inappropriate descriptions) which are not grammar errors but should be considered in view of circuit designing.

So far, a style checker has been suggested which detects the portions violating naming rules or logic synthesis description rules (rules defining logic synthesis-capable descriptions), and outputs the specification of the violation. These portions do not correspond to grammar errors but should be considered in view of circuit designing. This style checker, however, is merely capable of outputting what the violation is, and incapable of automatically modifying the HDL description so as to evade the violation. Accordingly, the designer had to manually resolve the violation, making reference to the style checker's error message, thereby bearing a considerable burden. In particular, in case where two or more designers are involved in circuit designing in an HDL, there is a high possibility of multiple occurrences of the naming rule violations, which would necessitate a great amount of effort in their modifications.

Further, in the conventional techniques, some of the inappropriate HDL descriptions, which are not grammar errors but violates rules defining wire connections or the rules that should be considered in view of a hierarchical circuit design, cannot be detected by the front-end (language processor) but by the back-end (logic synthesis tool or verification tool). Even though such inappropriate descriptions are due to the designer's careless mistakes, it is difficult to find out them in an early stage, and is of course thoroughly difficult to automatically modify the descriptions, thereby causing future reworking in the designing process. For instance, if an HDL description is formed of a plurality of hierarchical levels, the case is often encountered where a terminal definition description in each level and a terminal description in an instance disagree. This disagreement is sometimes caused by mistake, and might sometimes be insignificant at all in terms of grammar and circuit expression. In the meantime, since a possibility cannot be eliminated that the disagreement would result in a future problem in circuit expression, thereby causing some reworking in a later stage, a technique has ever been longed for automatically removing the disagreement.

Furthermore, at describing a circuit design in an HDL, an originally employed HDL is often converted into another HDL (hereinafter called “the latter HDL”), for the purpose of establishing an inter-system linkage or due to some reasons raised in a design flow. At that time, there sometimes occurs a case where an HDL description that meets language rules of the current HDL would not comply with language rules of the latter HDL. In view of the probability, it has ever been longed that the original HDL description is allowed to be automatically modified in advance into a description that complies with the language rules of not only the current HDL but also the latter HDL, in order to prevent prospected defects in the circuit design.

And further, in an HDL description that is to be subjected to logic synthesis, there often remains a waveform observation-dedicated simulation description, which has been used at logic verification and is incapable of logic synthesis, without being annotated. Since it has long been impossible to automatically modify (delete) this type of logic synthesis-incapable description, the description had to be manually modified by a designer at its detection, and any action could not be taken unless an error is actually caused in a logic synthesis tool due to such a logic synthesis-incapable description.

### SUMMARY OF THE INVENTION

With the foregoing problems in view, objects of the present invention are to automatically modify serious semantic grammar errors and to clearly indicate the modified portions. Further objects of the present invention are to automatically modify the portions which are not grammar errors but should be considered in view of circuit designing and to clearly indicate the modified portions. As a result, burdens on designers would be significantly reduced and high-quality HDL descriptions would be obtained.

In order to accomplish the above objects, according to the present invention, there is provided an apparatus for automatically modifying an HDL description (circuit design information) described in a HDL, which apparatus comprises: HDL lexical analysis means for performing a lexical analysis of the HDL description which is to be modified; HDL syntax analysis means for performing a syntax analysis of the HDL description based on the result of the lexical analysis by the HDL lexical analysis means, to convert the HDL description into a parse tree format description; semantic grammar error detection means for performing semantic analysis of the HDL description based on the result of the syntax analysis by the HDL syntax analysis means, detecting a portion of the HDL description, in which portion variables on right and left sides of an assignment statement are inconsistent in type, and regarding the detected portion as a semantic-grammar-error portion; a type conversion template for defining a type conversion function, which converts the type of the variable on the right side of the assignment statement into that of the variable on the left side of the assignment statement, as a type conversion rule; semantic grammar error modifying means for modifying the semantic-grammar-error portion into a correct description by applying the type conversion function, which has been defined by the type conversion template, to the right side of the assignment statement which side has been regarded as the semantic-grammar-error portion by the semantic grammar error detecting means; HDL reverse syntax analysis means for performing a reverse syntax analysis of the HDL description, which has been modified by the semantic grammar error modifying means, to convert the HDL description from the parse tree format description into an ordinary format description; and comment attaching means for attaching a comment about the modification to the modified portion, which is the portion as the result of the modification by the semantic grammar error modifying means.

As one preferred feature, the apparatus further comprises: a control information template for defining a to-be-modified item (herein after called “object item”), which is not a grammar error but should be considered in view of circuit designing, and a modification rule to modify the object item; object item detecting means for detecting a portion corresponding to the object item in the HDL description, based on the result of the syntax analysis by the HDL syntax analysis means; and object item modifying means for modifying the last-named corresponding portion, which has been detected by the object item detecting means, in accordance with the modification rule defined by the control information template. The HDL reverse syntax analysis means is operable to perform a reverse syntax analysis of the modified HDL description, which is the description as the result of the modification by the semantic grammar error modifying means and the object item modifying means, and the comment attaching means is operable to attach a comment about the modification to the modified corresponding portion, which is the portion as the result of the modification by the semantic grammar error modifying means and the object item modifying means.

As one generic feature, the present invention provides an apparatus for automatically modifying an HDL description described in an HDL, which apparatus comprises: in addition to the above-described HDL lexical analysis means and HDL syntax analysis means, a control information template for defining a to-be-modified item (hereinafter called “object item”), which is not a grammar error but should be considered in view of circuit designing, and a modification rule to modify the object item; object item detecting means for detecting a portion corresponding to the object item in the HDL description, based on the result of the syntax analysis by the HDL syntax analysis means; object item modifying means for modifying the last-named corresponding portion, which has been detected by the object item detecting means, in accordance with the modification rule defined by the control information template; HDL reverse syntax analysis means for performing reverse syntax analysis of the modified HDL description, which is the description as the result of the modification by the object item modifying means, to convert the HDL description from the parse tree format description into an ordinary description; and comment attaching means for attaching a comment about the modification to the modified corresponding portion, which is the portion as the result of the modification by the object item modifying means.

As another generic feature, the present invention provides a computer-readable recording medium in which a program for automatically modifying an HDL description described in an HDL is recorded, wherein the program instructs a computer to function as the above-described HDL lexical analysis means, HDL syntax analysis means, object item detecting means, object item modifying means, HDL reverse syntax analysis means, and comment attaching means.

The automated HDL modifying apparatus and the computer-readable recording medium in which a program for automatically modifying HDL is recorded, according to the present invention, guarantee the following advantageous results.

(1) Since serious semantic grammar errors are automatically modified and the modified portions are clearly shown, it is possible to significantly reduce burdens on designers, and also possible to obtain a high-quality HDL description.

(2) Partly since a portion which is not a grammar error but should be considered in view of circuit designing is automatically modified into an appropriate description, and partly since the modified portion is clearly shown, it is possible to significantly reduce burdens on designers, and also possible to obtain a high-quality HDL description.

(3) By appropriately defining object items and modification rules in a control information template, it is possible to detect and automatically modify, in an early stage, a portion (in appropriate description) which should be considered in view of circuit designing and careless mistakes made by designers, thereby surely preventing the occurrence of reworking in the designing process.

(4) A modification comment is attached to the modified portion, making it possible for a designer to visually recognize where and in what way the modification has been performed. It is thus also possible for the designer to check, with ease and certainty, whether or not the result of the automatic modification complies with the designer's intention, and thereby burdens on the designer are significantly reduced.

(5) Such a modification comment attached to the modified portion informs the designer about in what situations he/she is apt to make modification-required descriptions, thereby exerting educational effects.

(6) By appropriately defining object items and modification rules in a control information template, it is possible, with consideration given to a possibility that a current HDL description being modified is converted into another HDL, to automatically modify the HDL description in advance so as to comply with language rules of not only the current HDL but also the latter HDL, thereby preventing the occurrence of circuit designing-relevant problems even after the conversion performed. Accordingly, it is possible to obtain a HDL description that would cause no problems in circuit designing even if employed in more than one HDL, without placing any burdens on designers.

(7) By appropriately defining object items and modification rules in a control information template, it is possible to automatically modify a character string that contains any prohibited character therein into a new character string that neither is contained in the HDL description nor includes any predetermined prohibited characters. Accordingly, even if two or more designers are involved in generating the HDL description, resulting in various violations of the naming rules, it is still possible to modify the names (character string) that are against the naming rules, with ease and certainty, thereby obtaining a modified HDL description that obeys the naming rules.

(8) By appropriately defining object items and modification rules in a control information template, it is possible to automatically modify terminal descriptions which are inconsistent between a plurality of hierarchical levels of the HDL description, into descriptions which are consistent between all of the plural hierarchical levels of the HDL description. Accordingly, it is thoroughly possible, in an early stage, to detect and automatically modify such inappropriate descriptions, which so far have been detected not by the front-end (language processor) but by the back-end (logic synthesis tool or verification tool), thereby surely preventing the occurrence of reworking in the designing process.

(9) By appropriately defining object items and modification rules in a control information template, it is possible to automatically modify a portion in which the relationship between the left side and the right side of a signal assignment description is incorrect, into a correct relationship.

(10) By appropriately defining object items and modification rules in a control information template, it is possible to automatically delete a portion in an HDL description whose synthesis is unavailable by a logic synthesis tool, or to add/write-in a directive for instructing the logic synthesis tool to ignore the portion. Hereby, even if a logic-synthesis-incapable waveform observation-dedicated simulation description, which has been used at the logic verification, remains in the HDL description without being annotated, there would be caused no problems (errors) in a logic synthesis tool. Accordingly, it is no longer necessary for designers to delete such synthesis-incapable descriptions by manual operation, thereby significantly reducing burdens on the designers.

Other objects and further features of the present invention will be apparent from the following detailed description when read in conjunction with the accompanying drawings.

### BRIEF DESCRIPTION OF THE DRAWINGS

FIG. 1 is a block diagram schematically showing an automated HDL modifying apparatus of one embodiment of the present invention; and

FIG. 2 through FIG. 9 are diagrams each illustrating operations of the automated HDL modifying apparatus of FIG. 1.

### DESCRIPTION OF THE PREFERRED EMBODIMENT(S)

One preferred embodiment of the present invention will now be described in detail with reference to relevant accompanying drawings.

[1] Construction of One Embodiment:

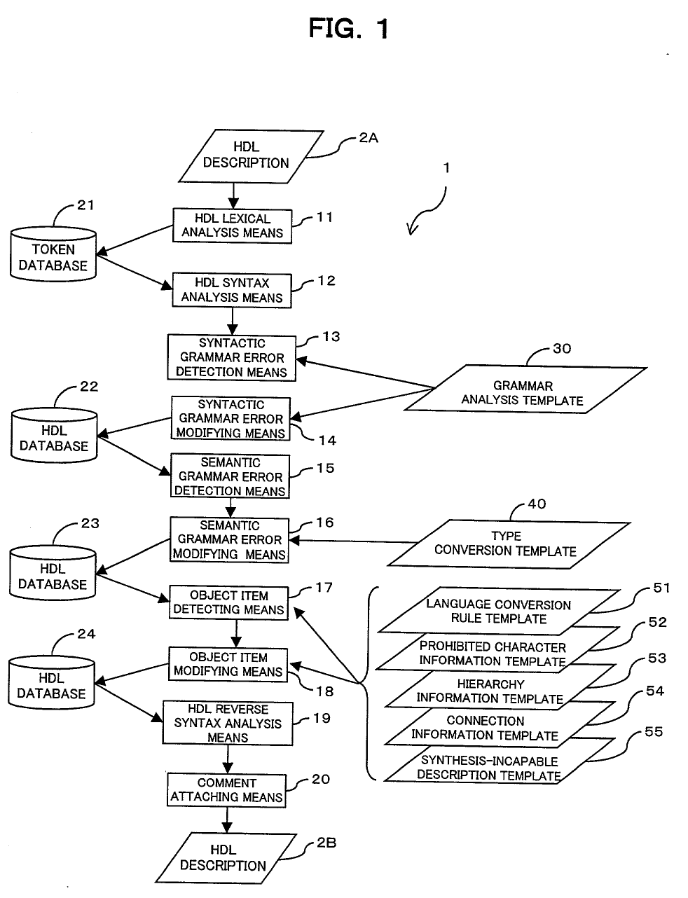

FIG. 1 depicts an automated HDL modifying apparatus of one embodiment of the present invention. Referring to FIG. 1, the present embodiment of automated HDL modifying apparatus 1, which modifies an HDL description (circuit design information described in HDL) in an automatic way, is shown to include HDL lexical analysis means 11, HDL syntax analysis means 12, syntactic grammar error detection means 13, syntactic grammar error modifying means 14, semantic grammar error detection means 15, semantic grammar error modifying means 16, object item detecting means 17, object item modifying means 18, HDL reverse syntax analysis means 19, comment attaching means 20, databases 21 through 24, and templates 30, 40, and 51 through 55.

HDL lexical analysis means 11 performs lexical analysis of HDL description (original HDL description) 2A which is to be modified: namely, parsing to-be-modified HDL description 2A into basic units of character string, or tokens, and writing the individual basic units, together with the information of their types, in token database 21.

HDL syntax analysis means 12, based on the tokens (the result of the analysis by HDL lexical analysis means 11) stored in token database 21, performs syntax analysis of HDL description 2A to convert into a parse tree format description.

Grammar analysis template 30 defines various rules: rules defining the use of reserved words; rules for spelling; and rules for syntax. Here, “syntax rules” mean syntactic grammar rules such as that a semicolon “;” should be written at the end of a statement that includes a “=” therein.

Syntactic grammar error detection means 13 detects syntactic grammar errors (incorrect spellings, statements that contain a “=” but with no “;” placed at their ends, reserved words incorrectly used, and others) based on grammar analysis template 30 and the result of the analysis by HDL syntax analysis means 12. Syntactic grammar error modifying means 14 modifies the syntactic grammar error, which has been detected by syntactic grammar error detection means 13, into a correct description in accordance with the rules defined by grammar analysis template 30.

The resulting modified description by syntactic grammar error modifying means 14 is written in HDL database 22. In this instance, if no syntactic grammar error is detected by syntactic grammar error detection means 13, the result of the analysis by HDL syntax analysis means 12 is written in HDL database 22 directly without undergoing the modification by syntactic grammar error modifying means 14.

Semantic grammar error detection means 15 performs semantic analysis of HDL description 2A based on the data (the result of the analysis by HDL syntax analysis means 12 or the result of the modification by syntactic grammar error modifying means 14) stored in HDL database 22, and detects a portion of the HDL description, in which portion variables on the right and the left sides of an assignment statement are inconsistent in type, as a semantic-grammar-error portion.

Type conversion template 40 defines a type conversion function, which converts the type of a variable on the right side of an assignment statement into that of a variable on the left side of the assignment statement, as a type conversion rule. The type conversion function will be described in detail later, making reference to Table 1.

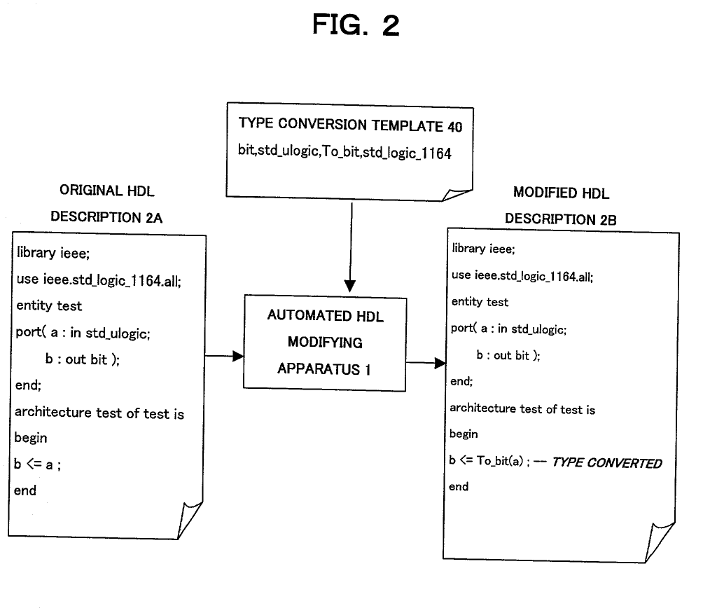

Semantic grammar error modifying means 16 modifies the semantic-grammar-error portion into a correct description by applying the type conversion function, which has been defined by the type conversion template 40, to the right side of the assignment statement which side has been regarded as the semantic-grammar-error portion by the semantic grammar error detection means 15. The resulting modified description is written in HDL database 23. Concrete modifying operations by automated HDL modifying apparatus 1 of the present embodiment will be described in detail later with reference to FIG. 2.

In this instance, if no semantic grammar error is detected by semantic grammar error detection means 15, semantic grammar error modifying means 16 performs no modification, and HDL database 23, as it is, serves as HDL database 23.

Templates (or control information templates) 51 through 55 define various types of to-be-modified items (hereinafter called “object item”), which are not grammar errors but should be considered in view of circuit designing, and modification rules for modifying the object items.

Object item detecting means 17 detects a portion corresponding to any one of the object items, which are defined by templates 51 through 55, in the HDL description 2A, based on the data (the result of the analysis by the HDL syntax analysis means 12 or the result of the modification by syntactic grammar error modifying means 14/semantic grammar error modifying means 16) stored in HDL database 23.

Object item modifying means 18 modifies the portion, which has been detected by object item detecting means 17, in accordance with the modification rules defined by templates 51 through 55. The resulting modified description is written in HDL database 24.

At that time, if no portion is detected that corresponds to any of the object items by object item detecting means 17, object item modifying means 18 performs no modification, and HDL database 23, as it is, serves as HDL database 24.

HDL reverse syntax analysis means 19 performs reverse syntax analysis of the data stored in HDL database 24, or the HDL description (a parse tree format description) which has been modified by syntactic grammar error modifying means 14, semantic grammar error modifying means 16, and object item modifying means 18, to convert the HDL description from the parse tree format description into an ordinary format description. The resulting converted description is output as modified HDL description 2B.

Comment attaching means 20 attaches a comment about the modification to the corresponding modified portion (the portion as the result of the modification by the syntactic grammar error modifying means 14, semantic grammar error modifying means 16, and object item modifying means 18). A concrete description of such comments that are attached to HDL description 2B will be described later, making reference with FIG. 2 through FIG. 9. Here, if automated HDL modifying apparatus 1 makes no modification to original HDL description 2A, comment attaching means 20, as a matter of course, attaches no comment to modified HDL description 2B, either. In the meantime, comment attaching means 20 also attaches a comment to modified HDL description 2B (source) output from HDL reverse syntax analysis means 19.

Hereinbelow, templates 51 through 55 will now be described in more details.

Object items to be modified are defined in language conversion rule template 51 in such a manner that, on the assumption that the HDL (say, VHDL) being currently modified is converted into another HDL (say, Verilog-HDL), object item detecting means 17 detects a portion of the current HDL description, which portion, after being converted, would not comply with language rules of the latter HDL, as a portion corresponding to the object item. Modification rules are defined in language conversion rule template 51 in such a manner that object item modifying means 18 modifies the last-specified corresponding portion, which has been detected by object item detecting means 17, into a correct description that would comply with language rules of the latter HDL after the conversion.

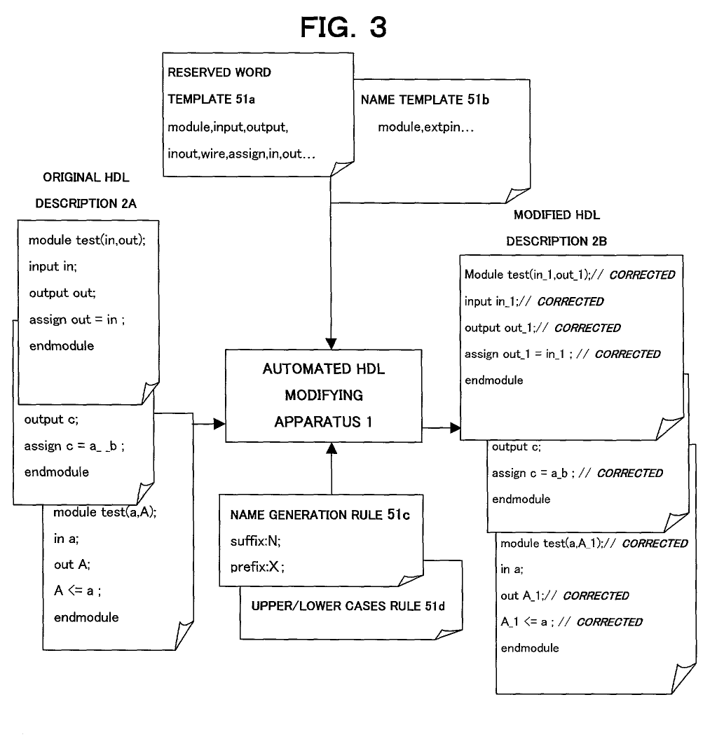

Referring now to FIG. 3, language conversion rule template 51 includes reserved word template 51a, name template 51b, name generation rule 51c, and upper/lower cases rule 51d. Reserved words template 51a registers/defines reserved words that are available for each HDL, and name template 51b registers/defines terminal names and net names that are available for each HDL. Name generation rule 51c defines rules for generating a new character string, which is unique and not contained in the HDL description, as a new terminal name or a new net name. Further, upper/lower cases rule 51d registers/defines whether or not each HDL is case-sensitive.

As described later with reference to FIG. 3, using reserved words template 51a and name template 51b, for example, if there is detected in a Verilog-HDL description a character string that is available as a terminal name or a net name in Verilog-HDL but is available as a reserved word in VHDL, the character string is converted/modified into another new character string that is not defined as a reserved word. At that time, in accordance with name generation rule 51c, a unique character string that is not contained in the HDL description is generated as the new character string.

If the current HDL, now being modified, is found to be case-sensitive (Verilog-HDL, for example) in accordance with upper/lower cases rule 51d (see FIG. 3), language conversion rule template 51 defines the object item in such a manner that, in consideration of a possibility that the current HDL might be converted into another HDL that is case-insensitive, object item detecting means 17 detects one of a pair of character strings which are composed of common characters arranged in the same order and described case-sensitively, as a portion corresponding to the object item. At that time, language conversion rule template 51 defines modification rules in such a manner that object item modifying means 18, in accordance with name generation rule 51c, generates a new character string that is not contained in the HDL description, and then replaces the above-mentioned one of the two character strings, which has been detected by the object item detecting means, with the thus generated new character string.

Otherwise if the current HDL is found to be case-insensitive (VHDL, for example) in accordance with upper/lower cases rule 51d (see FIG. 3), in consideration of a possibility that the current HDL might be converted into another HDL that is case-sensitive, language conversion rule template 51 defines the object item in such a manner that the object item detecting means 17 detects every upper case character or every lower case character in character strings in the HDL description, as a portion corresponding to the object item. At that time, language conversion rule template 51 defines modification rules in such a manner that object item modifying means 18 converts every upper case character into a lower case character, or every lower case character into an upper case character.

Concrete modifying operations with use of language conversion rule template 51 will be described in detail later with reference to FIG. 3.

Prohibited character information template 52 defines the object item in such a manner that the object item detecting means 17 detects a character string which includes any predetermined prohibited character, as a portion corresponding to the object item. Further, prohibited character information template 52 defines modification rules in such a manner that the object item modifying means 18 generates a new character string which neither is contained in the HDL description nor includes any predetermined prohibited character, and then replaces the prohibited-character-included character string, which has been detected by the object item detecting means 17, with the thus generated new character string.

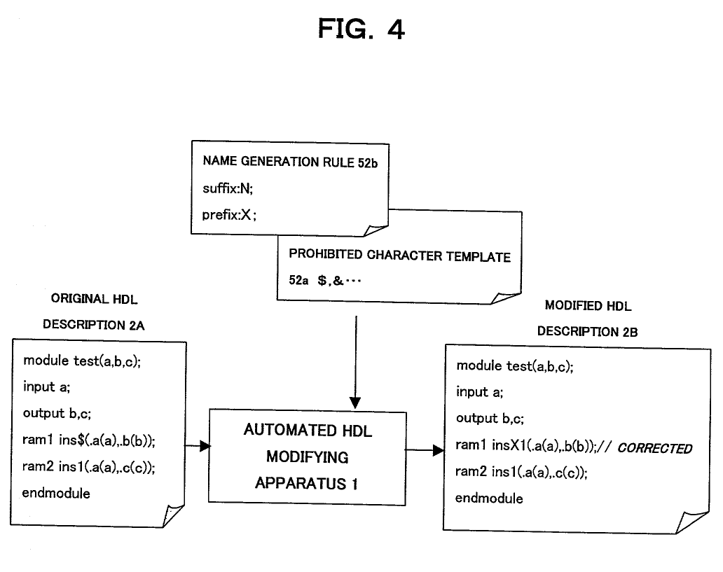

Referring now to FIG. 4, prohibited character information template 52 has prohibited character template 52a and name generation rule 52b. Prohibited character template 52a defines/registers unavailable character strings, and object item detecting means 17 detects a character string that contains any of the unavailable characters, making reference to prohibited character template 52a, as a portion corresponding to the object item. Name generation rule 52b, which is similar to name generation rule 51c, defines rules for generating a new, unique character string which neither is not contained in the HDL description nor includes any of the predetermined prohibited characters, and in accordance with this name generation rule 52b, object item modifying means 18 generates the above-mentioned new character string.

Concrete modifying operations with use of prohibited character information template 52 will be described in detail later with reference to FIG. 4.

Hierarchy information template 53 defines the object item to be modified in such a manner that object item detecting means 17 detects a portion of the HDL description, which portion is inconsistent in terminal description between a plurality of hierarchical levels of the HDL description, as a portion corresponding to the object item. Further, hierarchy information template 53 defines modification rules in such a manner that object item modifying means 18 modifies the inconsistent terminal description in the above-mentioned corresponding portion, which has been detected by object item detecting means 17, into a correct description which is consistent between all of the plural hierarchical levels of the HDL description.

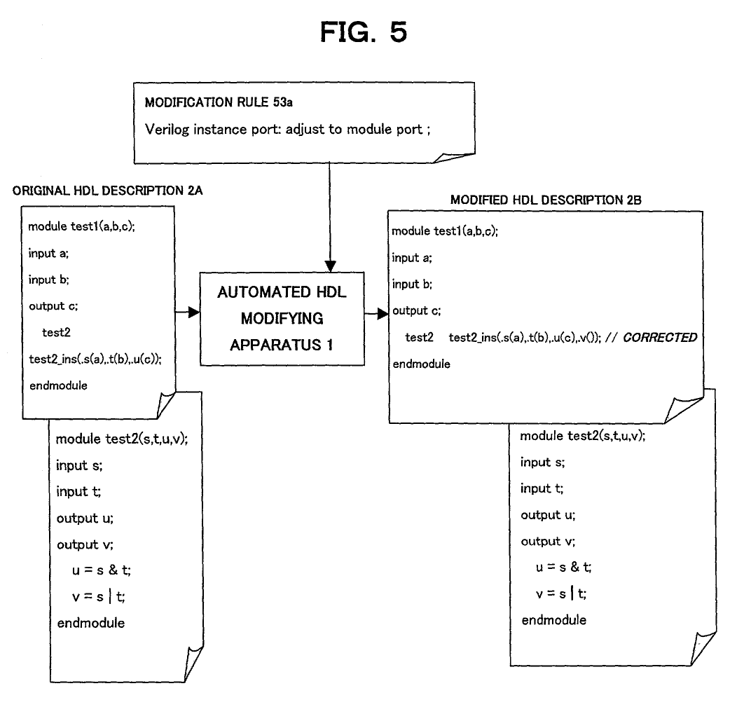

Concrete modifying operations with use of hierarchy information template 53 will be described in detail later with reference to FIG. 5 through FIG. 8. Further, hierarchy information template 53 has modification rules 53a through 53d as shown in FIG. 5 through FIG. 8, respectively. Such modification rules 53a through 53d will be described later in detail.

Connection information template 54 defines the object item in such a manner that object item detecting means 17 detects a portion of the HDL description, which portion yields an incorrect relationship between the left and the right sides of a signal assignment description, as a portion corresponding to the object item. Further, connection information template 54 defines modification rules in such a manner that object item modifying means 18 modifies the above-mentioned corresponding portion, which has been detected by object item detecting means 17, into a correct description which yields a correct relationship between the left and the right sides of the signal assignment description. Concrete modifying operations with use of connection information template 54 will be described later in detail.

Synthesis-incapable description template 55 defines the object item in such a manner that object item detecting means 17 detects a portion (synthesis-incapable portion) in the HDL description, which portion is unable to be synthesized by a logic synthesis tool, as a portion corresponding to the object item. Further, synthesis-incapable description template 55 defines modification rules in such a manner that the object item modifying means 18 deletes the above-mentioned corresponding portion, which has been detected by the object item detecting means 17, or that the object item modifying means 18 adds to the corresponding portion, which has been detected by the object item detecting means 17, a directive for instructing the logic synthesis tool to ignore the corresponding portion. The selection between the above two types of modification rules depends upon a designer.

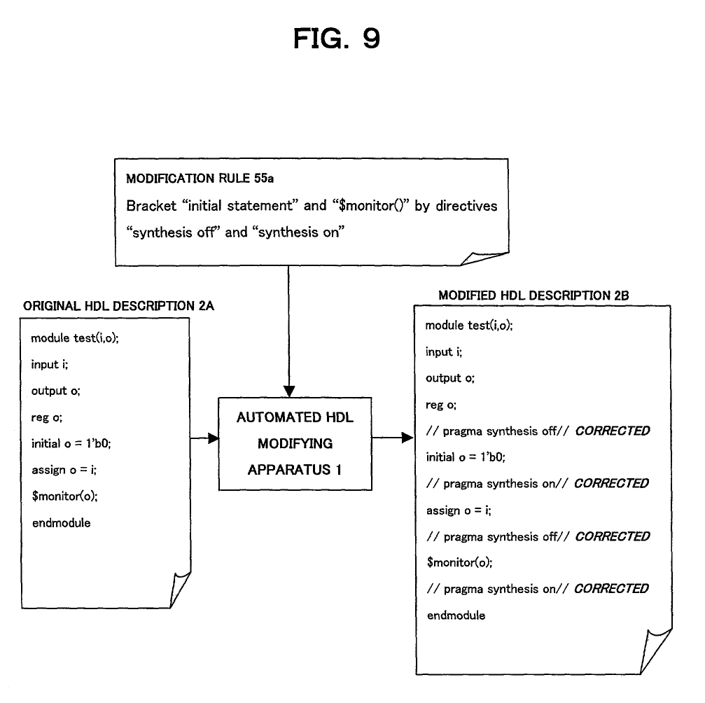

Concrete modifying operations with use of synthesis-incapable description template 55 will be described in detail later with reference to FIG. 9. Synthesis-incapable description template 55 has modification rule 55a of FIG. 9. As to modification rule 55a, a detailed description will be given later, and modification rule 55a of FIG. 9 is defined in such a manner that a directive is added/written in.

HDL lexical analysis means 11, HDL syntax analysis means 12, syntactic grammar error detection means 13, syntactic grammar error modifying means 14, semantic grammar error detection means 15, semantic grammar error modifying means 16, object item detecting means 17, object item modifying means 18, HDL reverse syntax analysis means 19, and comment attaching means 20 each can be realized by dedicated software (automated HDL modification program).

This automated HDL modification program is provided in the form of being recorded in a computer-readable recording medium such as a flexible disc and a CD-ROM. Also, in user, automated HDL modifying apparatus 1 can be realized as a computer (not shown) constituted by a CPU, a ROM, a RAM, and soon. The ROM stores the automated HDL modification program having been previously recorded therein, and the CPU reads out and executes the program, thereby realizing the functions of the above-described various means 11 through 20.

In the meantime, the automated HDL modification program could be stored alternatively in a storage device (recording medium) such as a magnetic disc, an optical disc, a magneto-optical disc, and others, so as to be transferred from such a storage device to the computer via a communication path.

Further, information defined in templates 30, 40, and 51 through 55, could be input manually by a designer through a keyboard, a mouse, and others. Or else, it could be input by way of a recording medium, separately, or it could also be provided as part of the automated HDL modification program.

Furthermore, aforementioned HDL databases 21 through 24 can be realized by either of the RAM or the recording medium such as a flexible disc, a CD-R, and a CD-RW.

[2] Operation of One Embodiment:

Next, a description of an operation of automated HDL modifying apparatus 1 of the present embodiment, being constructed as above, will now be given in more details.

Firstly, here will be briefly described a sequence of automated modification operations executed by automated HDL modifying apparatus 1 of the present embodiment.

After being input to automated HDL modifying apparatus 1, HDL description (original HDL description) 2A which is to be modified is parsed into basic units of character string, or tokens, by the HDL lexical analysis means 11, and the tokens are then written in token database 21.

On the basis of the tokens, HDL syntax analysis means 12 performs syntax analysis of HDL description 2A to convert it into a parse tree format description. Syntactic grammar error detection means 13, based on the resulting parse tree and grammar analysis template 30, detects syntactic grammar errors. If any syntactic grammar error is detected, syntactic grammar error modifying means 14 modifies the error into a correct description in accordance with the rules defined by grammar analysis template 30. The resulting modified description is written in HDL database 22.

The HDL description 2A, whose syntactic grammar errors have already been modified as above, is then subjected to semantic analysis by semantic grammar error detection means 15 based on the data stored in HDL database 22, and a portion of the HDL description, in which portion variables on the right and the left sides of an assignment statement are inconsistent in type, is resultantly detected as a semantic-grammar-error portion. If any semantic-grammar-error portion is detected, semantic grammar error modifying means 16 applies a type conversion function, which is defined by the type conversion template 40, to the right side of the assignment statement which side has been regarded as the semantic-grammar-error portion, and hereby the semantic grammar error is modified into a correct description, and the resulting modified description is written in HDL database 23.

Further, object item detecting means 17 detects in the HDL description 2A, whose semantic grammar errors have already been modified as above, portions corresponding to any of the object items that are defined by templates 51 through 55. Upon detection of such portions, if any, object item modifying means 18 modifies the portions in accordance with modification rules defined by templates 51 through 55. The resulting modified descriptions are written in HDL database 24.

The parse tree format HDL description, which has undergone the various types of modifications, is then converted into an ordinary format description by HDL reverse syntax analysis means 19, and output as modified HDL description 2B. Every modified portion in modified HDL description 2B has a comment about its modification attached thereto by comment attaching means 20.

Secondly, referring now to FIG. 2 through FIG. 9, a description will now be made hereinbelow of automated modification operations that automated HDL modifying apparatus 1 of the present embodiment executes upon an HDL description described in VHDL or Verilog-HDL. Here will be given concrete descriptions of semantic grammar errors, to-be-modified items (hereinafter called “object items”), modification operations for modifying the items, and comments attached to the modification results; these are all features of the present embodiment.

[2-1] Operations for Modifying Semantic Grammar Errors:

In some HDLs, say, VHDL, variables inconsistent in type between the right side and the left side of an assignment statement, are regarded as grammar errors. According to the present embodiment, upon detection of such a semantic grammar error by semantic grammar error detection means 15, semantic grammar error modifying means 16 automatically modifies the error using type conversion template 40, and the specification of the modification is attached/written-in, as a comment, to the modified portion in a source (modified HDL description 2B) by comment attaching means 20.

For example, referring to HDL description 2A (described in VHDL) of FIG. 2, the type of an input variable “a” (right side) is “std_ulogic”, while the type of an output variable “b” (left side) is “bit”. Since the type of the variable on the right side differs from that of the variable on the left side, a portion “b<=a;” in original HDL description 2A is detected as a semantic grammar error. This type-inconsistent portion is detected by semantic grammar error detection means 15 while it is searching HDL database 22.

Semantic grammar error modifying means 16 evaluates whether or not type conversion template 40 has a type conversion pattern (type conversion rule, type conversion function) that is required for modifying the type-inconsistent portion. Here, in type conversion template 40, the type conversion pattern (type conversion rule) “To_bit”, which is for use in case where the variable type on the left side is “bit” while that on the right side is “std_ulogic”, is provided/defined by a library “std _logic_{—}1164”.

Accordingly, the semantic grammar error portion “b<=a;” is automatically converted by semantic grammar error modifying means 16 into “b<=To_bit(a);” in modified HDL description 2B. Additionally, comment attaching means 20 puts a comment “--TYPE CONVERTED” after the resulting modified portion “b<=To_bit(a);”.

In this instance, type conversion template 40 defines typical type conversion patterns (type conversion rule, type conversion function) previously. Representative examples of such type conversion patterns are shown in the following Table 1. Further, a library statement and a use statement, which are for use in referring to a library and a package where a type conversion function is stored, could be automatically added, if necessary.

TABLE 1

| LEFT SIDE | RIGHT SIDE | LIBRARY | PACKAGE |
|---|---|---|---|
| bit | std_ulogic | std_logic_1164 | To_bit |
| bit_vector | std_logic_{—} | std_logic_1164 | To_bitvector |
| | vector | | |
| | std_ulogic_{—} | std_logic_1164 | To_bitvector |
| | vector | | |
| std_ulogic | bit | std_logic_1164 | To_StdULogic |
| std_ulogic_{—} | std_logic_{—} | std_logic_1164 | To_StdULogicVector |
| vector | vector | | |
| | bit_vector | std_logic_1164 | To_StdULogicVector |
| std_logic_{—} | bit_vector | std_logic_1164 | To_StdLogicVector |
| vector | std_ulogic_{—} | std_logic_1164 | To_StdLogicVector |
| | vector | | |
| | integer | std_logic_arith | CONV_STD_{—} |
| | | | LOGIC_VECTOR |
| | unsigned | std_logic_arith | CONV_STD_{—} |
| | | | LOGIC_VECTOR |
| | signed | std_logic_arith | CONV_STD_{—} |
| | | | LOGIC_VECTOR |
| | std_ulogic | std_logic_arith | CONV_STD_{—} |
| | | | LOGIC_VECTOR |
| boolean | std ulogic | std_logic_1164 | is_X |
| | std_logic_{—} | std_logic_1164 | is_X |
| | vector | | |
| | std_ulogic_{—} | std_logic_1164 | is_X |
| | vector | | |
| natural | unsigned | numeric_std | TO_INTEGER |
| integer | signed | numeric_std | TO_INTEGER |
| | std_logic_{—} | std_logic_signed | CONV_INTEGER |
| | vector | | |
| | unsigned | std_logic_arith | CONV_INTEGER |
| | signed | std_logic_arith | CONV_INTEGER |
| | std_ulogic | std_logic_arith | CONV_INTEGER |
| unsigned | natural | numeric_std | TO_UNSIGNED |
| | integer | std_logic_arith | CONV_UNSIGNED |
| | signed | std_logic_arith | CONV_UNSIGNED |
| | std_ulogic | std_logic_arith | CONV_UNSIGNED |
| signed | natual | numeric_std | TO_SIGNED |
| | integer | std_logic_arith | CONV_SIGNED |
| | unsigned | std_logic_arith | CONV_SIGNED |
| | std_ulogic | Std_logic_arith | CONV_SIGNED |

[2-2] Modification Operation with Language Conversion Rule Template:

In an HDL-used circuit designing, an initially used HDL is often converted into another HDL (hereinafter called “the latter HDL”), for the purpose of establishing an inter-system linkage or due to some reasons raised in a design flow. At that time, there sometimes occurs a case where an HDL description that meets language rules of the current HDL would not comply with language rules of the latter HDL. In view of such a probability (on the assumption of grammar errors caused after the HDL conversion), automated HDL modifying apparatus 1 of the present embodiment automatically modifies the current HDL description in advance into a description that complies with the language rules of the latter HDL so as to prevent any defects in circuit designing (grammar errors after the HDL conversion).

In other words, though some tools for converting an HDL into another HDL have already been provided in the market, the present embodiment executes no such HDL conversion actually, but checks the language rules of the latter HDL with consideration given to a prospective conversion of the current HDL into the latter HDL, and then carries out automatic modifications according to the check results. In this manner, since the language rules of the latter HDL are previously checked, it is possible to obtain HDL description 2B that would cause no problems in circuit designing even if employed in more than one HDL, without placing any burdens on designers. Accordingly, it is also possible to convert an HDL into another HDL at anytime, and even after the conversion carried out, it would no longer necessary to correct errors.

Referring now to FIG. 3, object item detecting means 17 of automated HDL modifying apparatus 1 of the present embodiment reads-in reserved words template 51a, name template 51b, upper/lower cases rule 51d, each of which is included in language conversion rule template 51, and detects a portion which does not meet the template 51a, 51b, or upper/lower cases rule 51d. The detected error portion is converted into a newly generated description (character string) that has been automatically generated according to name generation rule 51c. Further, not only such language rule errors prospected after the language conversion but also confusing descriptions are detected and automatically modified.

For example, HDL description 2A described in Verilog-HDL is checked by syntactic grammar error detection means 13 for Verilog-HDL reserved words, and also is checked by object item detecting means 17 for reserved words for another HDL, say, VHDL, using reserved words template 51a and name template 51b. At that time, reserved words template 51a defines/registers all the reserved words for all the HDLs into which the conversion is likely to be performed, and name template 51b registers/defines terminal names and net names available for the individual HDLs.

Referring now to HDL description 2A of FIG. 3, which is described in Verilog-HDL, “in” and “out” are used as a terminal name or a net name. Meanwhile, these are reserved words in VHDL, thus prohibited from being used as a terminal name or a net name. In this manner, if the descriptions “in” and “out”, which would cause errors after being converted into another HDL, are detected by object item detecting means 17 as to-be-modified (object) portions, object item modifying means 18 reads-in name generation rule 51c, in which suffixes, prefixes, connectives, and serial numbers are recorded, and automatically generates new descriptions “in_{—}1” and “out_{—}1” according to the rule 51c, as new character strings (names).

Each of the thus generated “in_{—}1” and “out_{—}1” is a unique character string that is not contained in HDL description 2A, and is available as a terminal name or a net name in both Verilog-HDL and VHDL.

The “in” and “out” are automatically replaced with “in_{—}1” and “out_{—}1”, respectively, in modified HDL description 2B, and there is added a comment “//CORRECTED” at the end of the modified line by comment attaching means 20.

Further, in HDL description 2A described in Verilog-HDL, the use of an “a_{——}b” (see FIG. 3) or a “$” as a part of the characters composing a net name agrees with language rules of Verilog-HDL, meanwhile it disagrees with language rules of VHDL. If such an HDL description 2A is converted from Verilog-HDL into VHDL, an error is likely to be caused, and thus object item modifying means 18 automatically generates a unique character string (name), as similar to the above-mentioned ones, and replaces the prospected error portion with the automatically generated name.

In FIG. 3, a character string “a_{——}b” in HDL description 2A is automatically replaced with “a_b” in modified HDL description 2B, and also, at the end of the modified line a modification comment “//CORRECTED” is added by comment attaching means 20.

Furthermore, note that Verilog-HDL is case-sensitive, while VHDL is case-insensitive. If HDL description 2A described in Verilog-HDL, being composed of both upper case characters and lower case characters, is converted into VHDL, there would be caused confusion. That is, an “a” is distinguished from an “A” in HDL description 2A of FIG. 3, while VHDL makes no distinction between an “a” and “A”, thus causing confusion.

Accordingly, in automated HDL modifying apparatus 1, with consideration given to the possibility that Verilog-HDL is converted into VHDL, object item detecting means 17 detects either one (“A” in this example) of the character strings “A” and “a”, which are composed of a common character and described case-sensitively, as an object item to be modified, and object item modifying means 18 automatically generates a unique character string (name) “A_{—}1” according to name generation rule 51c. The newly generated character string is a unique one that does not overlap any existing character string in the HDL description.

After that, each character “A” in HDL description 2A is replaced with a character string “A_{—}1” in modified HDL description 2B, and at the end of the modified line, comment attaching means 20 attaches a modification comment “//CORRECTED”. In this manner, each “A” is replaced with an “A_{—}1”, thereby made distinguishable from the name “a” not only in Verilog-HDL but also in VHDL.

On the contrary, at checking an HDL description described in VHDL, which is case-insensitive, with consideration given to a possibility that the description is converted into Verilog-VHDL, which is case-sensitive, object item detecting means 17 detects every upper case character or every lower case character in character strings, as a portion corresponding to an object item to be modified, and object item modifying means 18 automatically converts every upper case character into a lower case character, or every lower case character into an upper case character. In other words, after the modification performed, all the characters in the HDL description described in VHDL are either in uppercase only or in lowercase only.

In VHDL, for example, a terminal name “b” is regarded as the same as a terminal name “B”, while in Verilog-HDL, these are regarded as the two different terminal names, hereby often causing confusion. In automated HDL modifying apparatus 1 of the present embodiment, however, HDL description 2A in VHDL is written either in uppercase only or in lowercase only, and the above “b” and “B” are uniformed into either one of them, thereby preventing such confusion.

[2-3] Modification Operation with Prohibited Character Template:

At circuit designing in an HDL, there is often a case where two or more designers are involved or where some tools are employed. In such a design, name rules become often inconsistent throughout the HDL description. For this reason, in view of an interface between the tools and a prospective conversion into another HDL, the names have been uniformed manually.

Meanwhile, object item detecting means 17 of automated HDL modifying apparatus 1, as shown in FIG. 4, reads-in prohibited character template 52a included in prohibited character information template 52, and using the prohibited character template 52a, object item detecting means 17 checks HDL description 2A for prohibited characters. If any prohibited character is found to be used in module names, external terminal names, instance names, net names, type names, component names, aliases for external terminals, or others, the character string (name) that includes any prohibited character is converted into a new name (character string) which is generated according to name generation rule 52b.

Referring now to FIG. 4, using prohibited character template 52a that registers prohibited characters of “$” and “&”, object item detecting means 17 checks HDL description 2A described in Verilog-HDL for these prohibited characters “$” and “&”. At that time, in the example of FIG. 4, a character “$”, which is used as an instance name, is detected as an object item to be modified, and object item modifying means 18 generates a new character string (name), say, “X1”, which neither is contained in to-be-modified HDL description 2A nor includes any predetermined prohibited character, in accordance with name generation rule 52b (here, “prefix:X;”)

The character “$” in HDL description 2A is automatically replaced with the new character string “X1” in modified HDL description 2B, and at the end of the statement, comment attaching means 20 attaches a modification comment “//CORRECTED”.

Hereby, even if two or more designers generate HDL description 2A, making various violations of the naming rules, it is still possible to correct the names (character strings) which are against the naming rules, with ease and certainty, thereby obtaining modified HDL description 2B that obeys the naming rules.

[2-4] Modification Operation with Hierarchy Information Template:

In HDL description 2A having a multi-level hierarchical structure (see FIG. 5, for example), there is often a case where an inconsistency (disagreement) is found between a terminal definition description in each hierarchy and a terminal description of an instance. Such inconsistencies in terminal descriptions are caused sometimes due to grammar errors made by designers, or sometimes due to descriptions which are not grammar errors but inappropriate as circuit descriptions. In these cases, the inconsistencies are preferred to be resolved.

Further, since Verilog-HDL is a type of language in which some terminal descriptions are optional, the above inconsistencies in the terminal descriptions are usually seen in an HDL description described in Verilog-HDL. Although such inconsistencies are not defects or errors in circuit descriptions, it is preferred, for purpose of safety, that the description is as clear as possible with no such inconsistencies.

Accordingly, in automated HDL modifying apparatus 1 of the present embodiment, the following rules are defined as modification rules 53a through 53d, respectively, of hierarchy information template 53:

(1) all the module port names (terminal names) are to be recited in each instance (see FIG. 5);

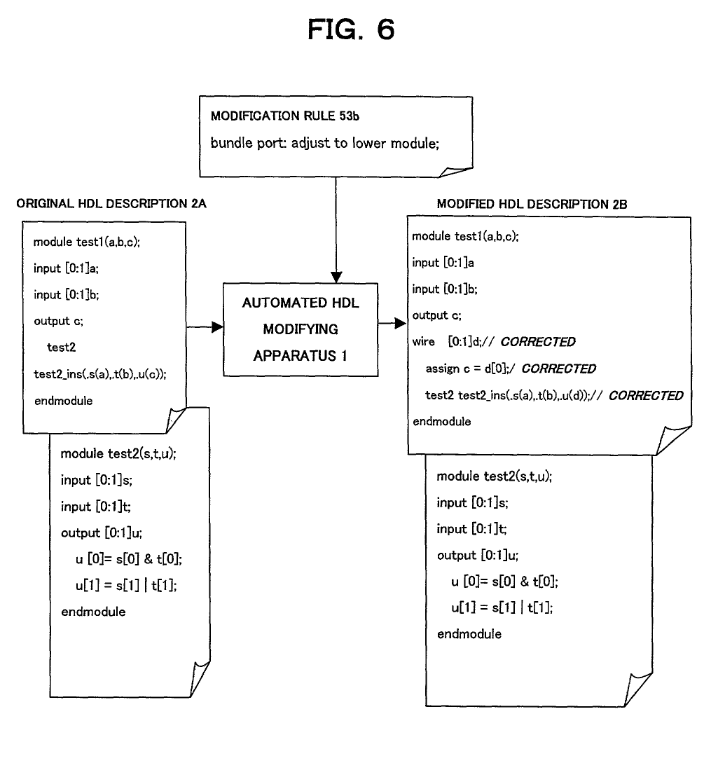

(2) a bit width description in an upper level hierarchy is to be matched with that in an lower level hierarchy (see FIG. 6);

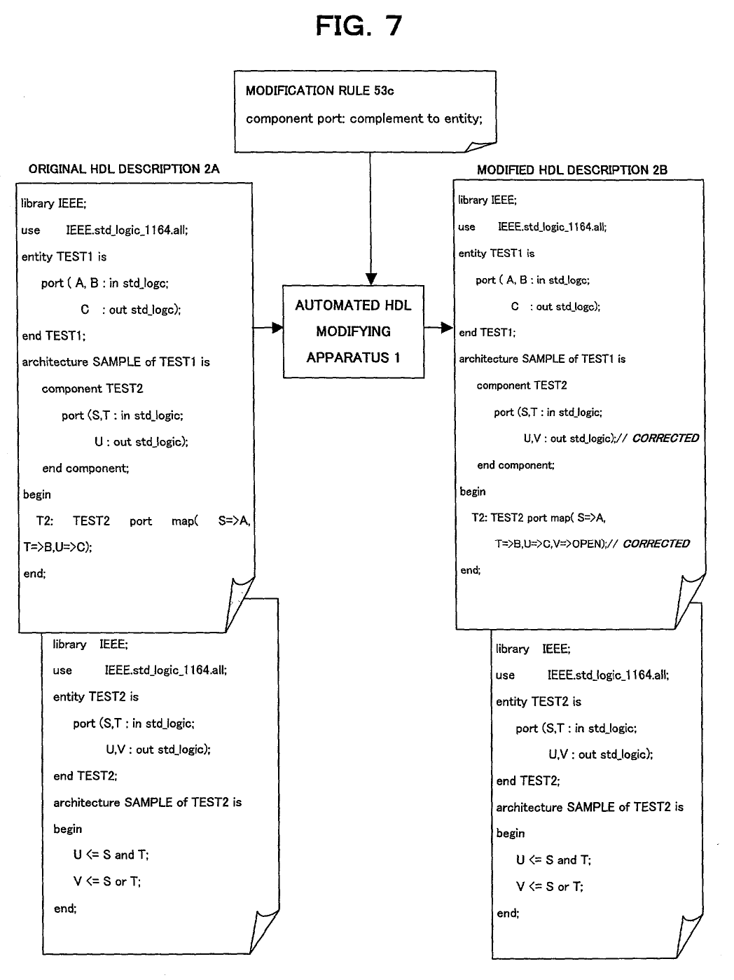

(3) a component port description in an upper level hierarchy is to be matched with that in an lower level hierarchy (see FIG. 7); and

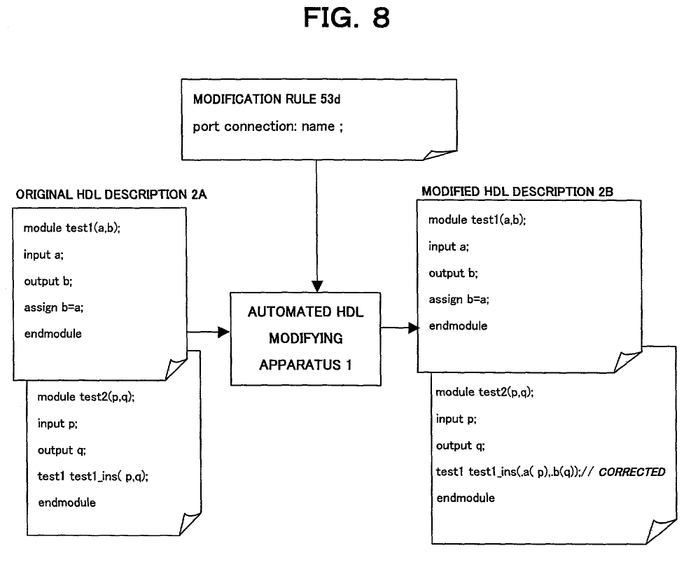

(4) port names (terminal names) in instances are to be described in an uniform fashion: a name-adapted fashion or a position-adapted fashion (see FIG. 8).

In accordance with these modification rules 53a through 53d, object item detecting means 17 detects a portion of the HDL description, which portion is inconsistent in terminal description (port name description) between a plurality of hierarchical levels of the HDL description, as a portion corresponding to an object item to be modified. Object item modifying means 18 then modifies the terminal description in the detected portion into a description that is consistent between all of the plural hierarchical levels of the HDL description, according to the control information (hierarchy information template 53) that defines language grammar and modification rules 53a through 53d.

In HDL description 2A described in Verilog-HDL with a hierarchical structure, it is not necessary to recite unassigned lower-level terminal names in an instance. If Verilog-HDL is converted into VHDL, or if it is desired to show explicitly that the terminals are unassigned ones, however, it is more convenient to recite all the lower level terminal names, and thus modification rule 53a (Verilog instance port: adjust to module port;)—all the terminal names (port names) are to be recited in each instance—is defined/registered in hierarchy information template 53 as the control information.

Referring now to HDL description 2A of FIG. 5, although four terminal names “s”, “t”, “u”, and “v” are shown in the lower level, the terminal name “v” is not recited in the instance in the upper level, as a terminal having the terminal name “v” is an unassigned one. Once this HDL description 2A is input to automated HDL modifying apparatus 1, the description “ins(.s(a),.t(b),.u(c))”, in which the unassigned terminal name “v” is omitted (hereinafter this kind of description will be called “omission description”), is automatically modified into “ins(.s(a),.t(b),.u(c),.v( ))”, in which all the terminal names are recited, in modified HDL description 2B. And further, at the end of each modified line, comment attaching means 20 attaches a modification comment “//CORRECTED”. Hereby, even unassigned terminals, if any, are explicitly shown, and conversion of the description from Verilog-HDL into VHDL is attainable.

Referring now to FIG. 6, in HDL description 2A in Verilog-HDL, output u is described to take two bits [0:1] in the lower level, while in the upper level, output c, which corresponds to output u, is described to be one bit, with the omission of description of the remaining unused one bit of output u in the instance.

At that time, if modification rule 53b (bundle port: adjust to lower module)—in case of disagreement in bit width between two or more hierarchical levels, the bit width in the instance in an upper level should be matched to that of the module in a lower level—is defined/registered in hierarchy information template 53 as control information, HDL description 2A of FIG. 6 is automatically modified into modified HDL description 2B, in which the bit width description in the upper level in the instance is matched with that in the lower level, and then at the end of each modified line, a modification comment “//CORRECTED” is attached. Hereby, it is made clear that in the upper level, one of the two bits of output u is unused.

Additionally, in modified HDL description 2B of FIG. 6, 2-bit signal d is newly defined (wire[0:1] d;), and one of the two bits of signal d is assigned to signal c (assign c=d[0];), and also, signal d and output u are associated with one another (“ins(.s(a),.t(b),.u(d))”).

In a hierarchical HDL description 2A described in VHDL, if a component port description in an upper level is consistent with an entity port description in a lower level, it is sometimes impossible to collectively process both the upper and lower levels. For example, in HDL description 2A of FIG. 7, entity port name V is written in the lower level, while the port name V is omitted in the upper level since a port having port name V is not assigned.

At that time, if modification rule 53c (component port: complement to entity)—a component description in an upper level should be matched to an entity port description in a lower level—is defined/registered in hierarchy information template 53 as control information, omission descriptions “port(S,T:in std_logic;U:out std_logic” and “port map(S=>A,T=>B,U=>C)” in HDL description 2A of FIG. 7 are automatically modified into “port(S,T:in std_logic;U,V:out std_logic” and “port map(S=>A, T=>B, U=>C, V=>OPEN)”, respectively, in which the component description in the upper level is matched to the entity port description in the lower level. And further, the end of each modified line, comment attaching means 20 attaches a modification comment “//CORRECTED”. Hereby, it is made clear that unassigned port V exists in the upper level.

Referring now to HDL description 2A of FIG. 8, port position-adapted descriptions and port name-adapted descriptions are both grammatically correct, but with the necessity of the uniformity of the descriptions, modification rule 53d (port connection:name;)—port names (terminal names) in instances should be written in a uniform fashion, in either of a name-adapted or a position-adapted fashion—is defined/registered in hierarchy information template 53 as control information.

For example, as shown in FIG. 8, if HDL description 2A is described in a port position-adapted fashion, and also if modification rule 53d instructs the description to be modified into a port name-adapted fashion, “test1 test1_ins (p, q);” in HDL description 2A is automatically modified into “test1 test1_ins(.a(p),.b(q));” in modified HDL description 2B, and at the end of the modified line, comment attaching means 20 attaches a modification comment “//CORRECTED”. Hereby, port names (terminal names) are described in instances in a uniform fashion, either of a name-adapted fashion or a position-adapted fashion.

As described above, by appropriately defining object items and modification rules in hierarchy information template 53, it is possible to automatically modify the terminal descriptions which are inconsistent between a plurality of hierarchical levels of the HDL description 2A, into the descriptions which are consistent between all of the plural hierarchical levels of the HDL description. Accordingly, it is possible, in an early stage, to detect and automatically modify such inappropriate descriptions, which so far have been detected not by the front-end (language processor) but by the back-end (logic synthesis tool or verification tool), thereby surely preventing the occurrence of reworking in the designing process.

[2-5] Modification Operation with Connection Information Template:

In HDLs, since a signal assignment description is the basics of operational specification in the RTL (Register Transfer Level) description, there is a low possibility that the left side and the right side of the description are confused. However, in structure descriptions, since a huge amount of descriptions, though simple ones, are sometimes made, the possibility cannot be eliminated completely. Generally speaking, in HDLs, there are grammatical rules for descriptions of ports (terminals) and signal assignment. In VHDL, in particular, the following directions are defined for five types of ports, “in”, “out”, “inout”, “buffer”, and “linkage”. In other words, it is possible to represent on which side of the left one and the right one of a signal assignment statement the above five types of ports are to be written, in the form of the following rules.

| | |
|---|---|
| in | right side only |
| out | left side only |
| inout | either of the two sides |
| buffer | either of the two sides |
| linkage | either of the two sides |

Likewise, in Verilog-HDL, the following directions are defined for three types of ports, “input”, “output”, and “inout”.

| | |
|---|---|
| input | right side only |
| output | left side only |
| inout | either of the two sides |

In automated HDL modifying apparatus 1 of the present embodiment, the above directions are applied as modification rules contained in connection information template 54, and thereby, object item detecting means 17 detects a portion which yields an incorrect relationship between the left side and the right side of a signal assignment description, as an object item to be modified, and object item modifying means 18 then modifies the thus detected incorrect relationship into a correct one according to the above modification rules (directions).

For example, assuming the following signal assignment description is included in HDL description 2A described in VHDL, it is inappropriate, yet not ungrammatical, that signal b of an output terminal is input to input terminal a.

module test(a,b);

input a;

output b;

assign a=b;

endmodule

Here, the following modification rules are defined in connection information template 54:

| | |
|---|---|
| input:right | # input terminal must be on the right |
| | side |
| output:left | # output terminal must be on the left |
| | side |
| inout:both | # inout terminal can be on either side |

Hereby, the validity of the both sides of each signal assignment description in HDL description 2A is checked. If any reverse description is found, it is automatically modified, thereby generating/outputting modified HDL description 2B. At this time, also, at the end of the modified line, comment attaching means 20 attaches a modification comment “//CORRECTED”.

Consequently, the resulting modified HDL description 2B is as follows:

module test(a,b);

input a;

output b;

assign b=a; //CORRECTED

endmodule

As described above, by appropriately defining object items and modification rules in connection information template 54, it is possible to automatically modify the portion in which the relationship between the left side and the right side of a signal assignment description is incorrect, into a correct relationship. And also, by using different modification rules for different HDLs, it is possible to automatically carry out an appropriate modification according to the language specification of each HDL.

[2-6] Modification Operation with Synthesis-incapable Description Template:

In an HDL description that is to be subjected to logic synthesis, there often remains a waveform observation-dedicated simulation description, which has been used in logic verification and is incapable of being logically synthesized, without being annotated.

Accordingly, in automated HDL modifying apparatus 1, modification rule 55a (see FIG. 9) of synthesis-incapable description template 55 recites all the waveform observation-dedicated simulation descriptions which are incapable of being logically synthesized, and also designates whether to delete the descriptions or to added/written-in directives for instructing a logic synthesis tool to ignore the descriptions. At that time, such directives are written so as to sandwich the corresponding description, and the logic synthesis tool ignores the sandwiched description, coping with the description as not being the subject of logic synthesis. In this instance, it is a designer who decides whether to delete or to ignore the description.

For example, in FIG. 9, modification rule 55a of synthesis-incapable description template 55 recites initial statement and “$monitor( )” as logic-synthesis-incapable waveform observation-dedicated simulation descriptions, and designates that these descriptions are to be sandwiched with synthesis on/off directives.

In HDL description 2A of FIG. 9, “initial o=1′b0;” and “$monitor (o);” are logic-synthesis-incapable waveform observation-dedicated simulation descriptions, which are detected by object item detecting means 17. Object item modifying means 18 automatically adds/writes-in synthesis off/on directives before and after the description (see modified HDL description 2B of FIG. 9), and at the end of each added/written-in portion (modified portion), comment attaching means 20 attaches a modification comment “//CORRECTED”.

Hereby, even if logic-synthesis-incapable waveform observation-dedicated simulation descriptions “initial o=1′b0;” and “$monitor (o);”, which has been used in logic verification, remains in HDL description 2A without being annotated, there would be caused no problems (errors) with a logic synthesis tool. Accordingly, it is no longer required for designers to delete such synthesis-incapable descriptions by manual operation, thereby significantly reducing burdens of the designers.

[3] Effects of one Embodiment:

In this manner, with automated HDL modifying apparatus 1 of one embodiment of the present invention, it is possible to detect inappropriate descriptions in HDL description 2A, and it is also possible to generate modified HDL description 2B in which such inappropriate descriptions have been modified into appropriate descriptions, thereby guaranteeing high-quality HDL description 2B.

In the present embodiment, in particular, since serious semantic grammar errors are automatically modified and the modified portions are clearly shown, it is possible to significantly reduce burdens on designers, and also possible to obtain high-quality modified HDL description 2B. Further, partly since a portion (corresponding to to-be-modified object item) which is not a grammar error but should be considered in view of circuit designing is automatically modified into an appropriate description, and partly since the modified portion is clearly shown, it is possible to significantly reduce burdens on designers, and also possible to obtain high-quality modified HDL description 2B.

Still further, by appropriately defining object items and modification rules in templates 51 through 55, it is possible to detect and automatically modify, in an early stage, a portion (an appropriate description) which should be considered in view of circuit designing and careless mistakes made by designers, thereby surely preventing the occurrence of reworking in the designing process.

Such inappropriate descriptions often express circuit functions or structures that are apart from a designer's intention. The errors would be discovered later in a subsequent logic verification process or in a circuit packaging process, and the modification operation would be accordingly necessitate. With automated HDL modifying apparatus 1 of the present embodiment, however, such inappropriate descriptions are modified earlier, at the time of generation of the HDL description, thereby eliminating future time-consuming modification operations.

Additionally, since modification comments (notes) are attached to modified portions, clearly indicating the modified portions, thus making it possible for a designer to visually recognize where and in what way the modifications have been performed. Accordingly, it is also possible for the designer to check, with ease and certainty, whether or not the results of the automatic modifications comply with their intentions, and thus burdens on the designer are significantly reduced.

Moreover, the modification comments attached to modified HDL description 2B inform the designers about in what situations they are apt to make modification-required descriptions, thereby exerting educational effects on the designers.

[4] Others:

Further, the present invention should by no means be limited to the above-illustrated embodiment, but various changes or modifications may be suggested without departing from the gist of the invention.

For example, although in the above embodiment, the explanation was given in case where the HDL is VHDL or Verilog-HDL, the present invention would be applicable also to other languages. In this case, similar effects and profits to those in the above expressions are also guaranteed, and the present invention would significantly contribute to the promoted efficiency and reduced efforts in the fields of circuit designing and software development.

What is claimed is:

1. An apparatus for automatically modifying circuit design information (hereinafter called the HDL description) described in a hardware description language (HDL), said apparatus comprising:
(a) HDL lexical analysis means for performing a lexical analysis of the HDL description which is to be modified;
(b) HDL syntax analysis means for performing a syntax analysis of the HDL description based on the result of the lexical analysis by said HDL lexical analysis means, to convert the HDL description into a parse tree format description;
(c) semantic grammar error detection means for performing semantic analysis of the HDL description based on the result of the syntax analysis by said HDL syntax analysis means, detecting a portion of the HDL description, in which portion variables on right and left sides of an assignment statement are inconsistent in type, and regarding the detected portion as a semantic-grammar-error portion;
(d) a type conversion template for defining a type conversion function, which converts the type of the variable on the right side of the assignment statement into that of the variable on the left side of the assignment statement, as a type conversion rule;
(e) semantic grammar error modifying means for modifying said semantic-grammar-error portion into a correct description by applying said type conversion function, which has been defined by said type conversion template, to the right side of the assignment statement which side has been regarded as said semantic-grammar-error portion by said semantic grammar error detecting means;
(f) HDL reverse syntax analysis means for performing a reverse syntax analysis of the HDL description, which has been modified by said semantic grammar error modifying means, to convert the HDL description from said parse tree format description into an ordinary format description; and
(g) comment attaching means for attaching a comment about the modification to the modified portion, which is the portion as the result of the modification by said semantic grammar error modifying means.

2. An apparatus according to claim 1, further comprising:
(h) a control information template for defining a to-be-modified item (hereinafter called “object item”), which is not a grammar error but should be considered in view of circuit designing, and a modification rule to modify said object item;
(i) object item detecting means for detecting a portion corresponding to said object item in the HDL description, based on the result of the syntax analysis by said HDL syntax analysis means; and
(j) object item modifying means for modifying the last-named corresponding portion, which has been detected by said object item detecting means, in accordance with said modification rule defined by said control information template;
said HDL reverse syntax analysis means being operable to perform a reverse syntax analysis of the modified HDL description, which is the description as the result of the modification by said semantic grammar error modifying means and said object item modifying means;
said comment attaching means being operable to attach a comment about the modification to the modified corresponding portion, which is the portion as the result of the modification by said semantic grammar error modifying means and said object item modifying means.

3. An apparatus for automatically modifying circuit design information (hereinafter called the HDL description) described in a hardware description language (HDL), said apparatus comprising:
(a) HDL lexical analysis means for performing a lexical analysis of the HDL description which is to be modified;
(b) HDL syntax analysis means for performing a syntax analysis of the HDL description based on the result of the lexical analysis by said HDL lexical analysis means, to convert the HDL description into a parse tree format description;
(c) a control information template for defining a to-be-modified item (hereinafter called “object item”), which is not a grammar error but should be considered in view of circuit designing, and a modification rule to modify said object item;
(d) object item detecting means for detecting a portion corresponding to said object item in the HDL description, based on the result of the syntax analysis by said HDL syntax analysis means;
(e) object item modifying means for modifying the last-named corresponding portion, which has been detected by said object item detecting means, in accordance with said modification rule defined by said control information template;
(f) HDL reverse syntax analysis means for performing reverse syntax analysis of the modified HDL description, which is the description as the result of the modification by said object item modifying means, to convert the HDL description from said parse tree format description into an ordinary description; and
(g) comment attaching means for attaching a comment about the modification to the modified corresponding portion, which is the portion as the result of the modification by said object item modifying means.

4. An apparatus according to claim 2, wherein said control information template defines:
said object item in such a manner that, on the assumption that the HDL being currently modified is converted into another HDL, said object item detecting means detects a portion of the current HDL description, which portion does not comply with language rules of the second-named HDL, as a portion corresponding to said object item; and
said modification rule in such a manner that said object item modifying means modifies the last-named corresponding portion, which has been detected by said object item detecting means, into a description that complies with the language rules of said second-named HDL.

5. An apparatus according to claim 3, wherein said control information template defines:
said object item in such a manner that, on the assumption that the HDL being currently modified is converted into another HDL, said object item detecting means detects a portion of the current HDL description, which portion does not comply with language rules of the second-named HDL, as a portion corresponding to said object item; and
said modification rule in such a manner that said object item modifying means modifies the last-named corresponding portion, which has been detected by said object item detecting means, into a description that complies with the language rules of said second-named HDL.

6. An apparatus according to claim 4, wherein if the current HDL is case-sensitive, in consideration of a possibility that the current HDL might be converted into another HDL that is case-insensitive, said control information template defines:
said object item in such a manner that said object item detecting means detects one of a pair of character strings which are composed of common characters arranged in the same order and described case-sensitively, as a portion corresponding to said object item; and
said modification rule in such a manner that said object item modifying means modifies the last-named corresponding portion, which has been detected by said object item detecting means, by generating a new character string that is not contained in the HDL description, and then replacing said one of the two character strings, which has been detected by said object item detecting means, with said new character string.

7. An apparatus according to claim 5, wherein if the current HDL is case-sensitive, in consideration of a possibility that the current HDL might be converted into another HDL that is case-insensitive, said control information template defines:
said object item in such a manner that said object item detecting means detects one of a pair of character strings which are composed of common characters arranged in the same order and described case-sensitively, as a portion corresponding to said object item; and
said modification rule in such a manner that said object item modifying means modifies the last-named corresponding portion, which has been detected by said object item detecting means, by generating a new character string that is not contained in the HDL description, and then replacing said one of the two character strings, which has been detected by said object item detecting means, with said new character string.

8. An apparatus according to claim 4, wherein if the current HDL is case-insensitive, in consideration of a possibility that the current HDL might be converted into another HDL that is case-sensitive, said control information template defines:
said object item in such a manner that said object item detecting means detects every upper case character or every lower case character in a character string, as a portion corresponding to said object item; and
said modification rule in such a manner that said object item modifying means modifies the last-named corresponding portion, which has been detected by said object item detecting means, by converting every upper case character into a lower case character, or every lower case character into an upper case character.

9. An apparatus according to claim 5, wherein if the current HDL is case-insensitive, in consideration of a possibility that the current HDL might be converted into another HDL that is case-sensitive, said control information template defines:
said object item in such a manner that said object item detecting means detects every upper case character or every lower case character in a character string, as a portion corresponding to said object item; and
said modification rule in such a manner that said object item modifying means modifies the last-named corresponding portion, which has been detected by said object item detecting means, by converting every upper case character into a lower case character, or every lower case character into an upper case character.

10. An apparatus according to claim 2, wherein said control information template defines:
said object item in such a manner that said object item detecting means detects a character string which includes a predetermined prohibited character, as a portion corresponding to said object item; and
said modification rule in such a manner that said object item modifying means modifies the last-named corresponding portion, which has been detected by said object item detecting means, by generating a new character string which neither is contained in the HDL description nor includes said predetermined prohibited character, and then replacing the prohibited-character-included character string, which has been detected by said object item detecting means, with said new character string.

11. An apparatus according to claim 3, wherein said control information template defines:
said object item in such a manner that said object item detecting means detects a character string which includes a predetermined prohibited character, as a portion corresponding to said object item; and
said modification rule in such a manner that said object item modifying means modifies the last-named corresponding portion, which has been detected by said object item detecting means, by generating a new character string which neither is contained in the HDL description nor includes said predetermined prohibited character, and then replacing the prohibited-character-included character string, which has been detected by said object item detecting means, with said new character string.

12. An apparatus according to claim 2, wherein said control information template defines:
said object item in such a manner that said object item detecting means detects a portion of the HDL description, which portion is inconsistent in terminal description between a plurality of hierarchical levels of the HDL description, as a portion corresponding to said object item; and
said modification rule in such a manner that said object item modifying means modifies the inconsistent terminal description in the last-named corresponding portion, which has been detected by said object item detecting means, into a correct description which is consistent between all of the plural hierarchical levels of the HDL description.

13. An apparatus according to claim 3, wherein said control information template defines:
said object item in such a manner that said object item detecting means detects a portion of the HDL description, which portion is inconsistent in terminal description between a plurality of hierarchical levels of the HDL description, as a portion corresponding to said object item; and
said modification rule in such a manner that said object item modifying means modifies the inconsistent terminal description in the last-named corresponding portion, which has been detected by said object item detecting means, into a correct description which is consistent between all of the plural hierarchical levels of the HDL description.

14. An apparatus according to claim 2, wherein said control information template defines:
said object item in such a manner that said object item detecting means detects a portion of the HDL description, which portion yields an incorrect relationship between the left and the right sides of a signal assignment description, as a portion corresponding to said object item; and
said modification rule in such a manner that said object item modifying means modifies the last-named corresponding portion, which has been detected by said object item detecting means, into a correct description which yields a correct relationship between the left and the right sides of said signal assignment description.

15. An apparatus according to claim 3, wherein said control information template defines:
said object item in such a manner that said object item detecting means detects a portion of the HDL description, which portion yields an incorrect relationship between the left and the right sides of a signal assignment description, as a portion corresponding to said object item; and
said modification rule in such a manner that said object item modifying means modifies the last-named corresponding portion, which has been detected by said object item detecting means, into a correct description which yields a correct relationship between the left and the right sides of said signal assignment description.

16. An apparatus according to claim 2, wherein said control information template defines:
said object item in such a manner that said object item detecting means detects a portion of the HDL description, which portion is unable to be synthesized by a logic synthesis tool, as a portion corresponding to said object item; and
said modification rule in such a manner that said object item modifying means deletes the last-named corresponding portion, which has been detected by said object item detecting means.

17. An apparatus according to claim 3, wherein said control information template defines:
said object item in such a manner that said object item detecting means detects a portion of the HDL description, which portion is unable to be synthesized by a logic synthesis tool, as a portion corresponding to said object item; and
said modification rule in such a manner that said object item modifying means deletes the last-named corresponding portion, which has been detected by said object item detecting means.

18. An apparatus according to claim 2, wherein said control information template defines:
said object item in such a manner that said object item detecting means detects a portion of the HDL description, which portion is unable to be synthesized by a logic synthesis tool, as a portion corresponding to said object item; and
said modification rule in such a manner that said object item modifying means adds to the last-named corresponding portion, which has been detected by said object item detecting means, a directive for instructing said logic synthesis tool to ignore said last-named corresponding portion.

19. An apparatus according to claim 3, wherein said control information template defines:
said object item in such a manner that said object item detecting means detects a portion of the HDL description, which portion is unable to be synthesized by a logic synthesis tool, as a portion corresponding to said object item; and
said modification rule in such a manner that said object item modifying means adds to the last-named corresponding portion, which has been detected by said object item detecting means, a directive for instructing said logic synthesis tool to ignore said last-named corresponding portion.

20. A computer-readable recording medium in which a program for automatically modifying circuit design information (hereinafter called the HDL description) described in a hardware description language (HDL) is recorded, wherein said program instructs a computer to function as the following:
(a) HDL lexical analysis means for performing a lexical analysis of the HDL description which is to be modified;
(b) HDL syntax analysis means for performing a syntax analysis of the HDL description based on the result of the lexical analysis by said HDL lexical analysis means, to convert the HDL description into a parse tree format description;
(c) semantic grammar error detection means for performing a semantic analysis of the HDL description based on the result of the syntax analysis by said HDL syntax analysis means, detecting a portion of the HDL description, in which portion variables on right and left sides of an assignment statement are inconsistent in type, and regarding the detected portion as a semantic-grammar-error portion;
(d) semantic grammar error modifying means for modifying said semantic-grammar-error portion into a correct description by applying a type conversion function, which converts the type of the variable on the right side of the assignment statement into that of the variable on the left side of the assignment statement, to the right side of the assignment statement which side has been regarded as said semantic-grammar-error portion by said semantic grammar error detecting means;
(e) HDL reverse syntax analysis means for performing a reverse syntax analysis of the HDL description, which has been modified by said semantic grammar error modifying means, to convert the HDL description from said parse tree format description into an ordinary format description; and
(f) comment attaching means for attaching a comment about the modification to the modified portion, which is the portion as the result of the modification by said semantic grammar error modifying means.

21. A computer-readable recording medium according to claim 20, wherein said program further instructs the computer to function as the following:
(g) object item detecting means for detecting a portion corresponding to a to-be-modified item (hereinafter called “object item”) in the HDL description, which item is not a grammar error but should be considered in view of circuit designing, based on the result of the syntax analysis by said HDL syntax analysis means; and
(h) object item modifying means for modifying the last-named corresponding portion, which has been detected by said object item detecting means, in accordance with a modification rule which has been defined previously for said object item;
said HDL reverse syntax analysis means being operable to perform a reverse syntax analysis of the modified HDL description, which is the description as the result of the modification by said semantic grammar error modifying means and said object item modifying means;
said comment attaching means being operable to attach a comment about the modification to the modified corresponding portion, which is the portion as the result of the modification by said semantic grammar error modifying means and said object item modifying means.

22. A computer-readable recording medium in which a program for automatically modifying circuit design information (hereinafter called the HDL description) described in a hardware description language (HDL) is recorded, wherein said program instructs a computer to function as the following:
(a) HDL lexical analysis means for performing a lexical analysis of the HDL description which is to be modified;
(b) HDL syntax analysis means for performing a syntax analysis of the HDL description based on the result of the lexical analysis by said HDL lexical analysis means, to convert the HDL description into a parse tree format description;
(c) object item detecting means for detecting a portion corresponding to a to-be-modified item (hereinafter called “object item”) in the HDL description, which item is not a grammar error but should be considered in view of circuit designing, based on the result of the syntax analysis by said HDL syntax analysis means;
(d) object item modifying means for modifying the last-named corresponding portion, which has been detected by said object item detecting means, in accordance with a modification rule which has been defined previously for said object item;
(e) HDL reverse syntax analysis means for performing a syntax analysis of the modified HDL description, which is the description as the result of the modification by said object item modifying means, to convert the HDL description from said parse tree format description into an ordinary format description; and
(f) comment attaching means for attaching a comment about the modification to the modified corresponding portion, which is the portion as the result of the modification by said object item modifying means.
